(19) United States
(12) Patent Application Publication
(10) Pub. No.: US 2022/0143879 A1
(43) Pub. Date: May 12, 2022

(54) DUAL EXPANDING FOAM FOR CLOSED MOLD COMPOSITE MANUFACTURING

(71) Applicant: Zephyros, Inc., Romeo, MI (US)

(72) Inventor: Jason Walker, Romeo, MI (US)

(21) Appl. No.: 17/430,615

(22) PCT Filed: Mar. 23, 2020
(86) PCT No.: PCT/US2020/024217

§ 371 Date: Aug. 12, 2021

Related U.S. Application Data
(60) Provisional application No. 62/823,430, filed on Mar. 25, 2019.
(60) Provisional application No. 62/981,193, filed on Feb. 25, 2020.

(51) Int. Cl. B29C 44/16; B29C 44/08; B29C 44/34; B29C 44/60

(52) U.S. Cl. CPC B29C 44/16; B29C 44/08; B29K 2063/00; B29C 44/60; B29C 44/3419

(57) ABSTRACT

A structure comprising: (i) a fiber and resin matrix material layer at least partially forming a hollow section of the structure; and (ii) a foamable material layer in direct planar contact with the fiber and resin matrix material layer, the foamable material layer at least partially filling the hollow section.

### TECHNICAL FIELD

The present teachings relate generally to the formation of composite structures utilizing an expanding foam. More particularly, the teachings are directed to composites formed by foamable layers for forming in-situ foam cores within a hollow composite structure.

### BACKGROUND

Hollow composite structures are typically manufactured utilizing air bladder structures to supply internal pressure to the material layers and force the layers toward the surface of a molding tool. The air bladders may remain within the structure or be removed, but they provide no additional benefit to the composite and they require additional manufacturing materials and processes.

Composite structures are disclosed in U.S. Published Application No. 2008/0241576.

What is needed is a hollow composite structure formation system that allows for formation within a mold without the use of air bladder structures in order to significantly reduce manufacturing time and materials.

### SUMMARY OF THE INVENTION

One or more of the above needs are met by the present teachings which contemplate hollow composite structures and methods for the manufacture of these hollow composite structures that utilize one or more foamable layers.

The teachings herein are directed to a structure comprising: (i) a fiber and resin matrix material layer at least partially forming a hollow section of the structure; and (ii) a foamable material layer in direct planar contact with the fiber and resin matrix material layer, the foamable material layer at least partially filling the hollow section. The fiber may comprise a carbon fiber. The resin may comprise an epoxy material. The resin may comprise a polyurethane material. The fiber may comprise a polymeric fiber. The foamable material layer may have a first expansion upon exposure to a first temperature and a second expansion upon exposure to a second temperature. The second expansion may occur in a molding device.

The foamable material may be a structural foam. The foamable material may be a sealing material. The foamable material may be a polymeric foam. The foamable material may comprise an epoxy resin, a phenoxy resin, an acetate (e.g., EVA or EMA), or any combination thereof.

The fiber may comprise a polyamide fiber. The fiber may comprise a glass fiber. The foamable material may expand upon exposure to a predetermined temperature. The structure may be located into a mold and heated so that the foamable material expands and cures. The resin may comprise a reformable resin material. The structure may be an elongated hollow part. The resin material may be a thermoset material. The resin material may be a thermoplastic material. The structure may form a portion of a frame member. The structure may be used as a building component, a component in a transportation vehicle, a furniture component or a sporting good component. The structure may form a portion of a bicycle frame.

### BRIEF DESCRIPTION OF THE DRAWINGS

FIG. 1 a perspective view of a composite in accordance with the present teachings.

FIG. 2 is a perspective view of a tool for manufacturing composites in accordance with the present teachings.

### DETAILED DESCRIPTION

The present teachings meet one or more of the above needs by the improved devices and methods described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The composites described herein may be formed as hollow or solid members comprising one or more foamable layers and one or more fibrous/resin matrix layers. The composites may include one or more resin materials and one or more fiber structures. The composites may also include additional foamable layers such as adhesive or sealant layers. Such adhesive or sealant layers may be activatable to foam and/or cure. The one or more adhesive or sealant layers may be activatable at ambient temperatures (e.g., a “foam in place” adhesive). Alternatively, the activatable adhesive or sealant may be activated using a stimulus (e.g., heat).

The resin may be a thermoplastic or thermoset resin. The resin may include a flame retardant component. The resin may include an epoxy material. The resin may include a polyurethane material. The resin may include an acrylic material.

The composites may be formed utilizing a plurality of reinforcement fibers which may be impregnated with the resin, which may be a thermoplastic or thermoset resin. The composites may be thermoformed as a pre-preg. The pre-preg may include a thermoplastic material which may be a thermoplastic material including at least one epoxide group. The composites may be formed utilizing a one or more fibrous materials, which may a lofted non-woven fibrous material, such as those described in U.S. Pat. Nos. 8,365,862; 9,033,101; 9,315,930; and 9,546,439, the contents of which are incorporated by reference herein for all purposes. The fibrous material may be a woven material. The fibrous material may have a wicking property. The fibrous material of may be used for gap filling or as matrix for a liquid resin. The fibers may be bonded together by an adhesive and/or resin material. The resin may be an acrylic resin, an epoxy resin, or any combination thereof. The composites may be formed of a thermoset material. The composites may be formed of a polyurethane material.

The composites may include one or more materials for providing vibration damping or sound attenuation (e.g., a sealing material). The sealing material may be an activatable material that expands and/or cures upon exposure to a stimulus. The composites may include adhesives, sealants, resins, or other materials.

The foamable layers may be located adjacent one or more surface layers for forming the hollow composite structure. Examples of suitable materials include metallic materials such as metal foil, aluminum or steel foil, plastic film or sheeting such as polypropylene or polyethylene film or polyethylene terephthalate film. It is preferred however that the material be a fibrous material. The surface layers may be porous so that a resin material can penetrate the pores in the surface layers so that the surface layers become embedded in the resin. It is also possible that the foamable layers may at least partially penetrate the pores formed in the fiber/resin layers. The surface layers may be the same or different and in some embodiments the layers may be selected to provide desired properties.

Where fibrous material is used it may be of any suitable material and its selection will depend upon the use to which the composite material is to be put. Examples of fibrous materials that may be used include woven and non-woven textile webs such as webs derived from polyester, polyamide, polyolefin, paper, carbon and kevlar fiber. These webs may be woven or obtained by non-woven web manufacturing techniques such as needle punching and point bonding. Metallic fibrous webs may also be used or glass fiber which may also be woven or non-woven. Other possible fibrous materials include carbon fiber and Kevlar.

The foamable materials may be a rigid epoxy foam. The foam layer may be a flexible foam. Rigid is defined as hard to the touch and resistant to manually applied pressure. It is preferred that the foam layer have a thickness of from 5 to 35 millimeters, preferably from 15 to 30 millimeters and most preferably from 20 to 25 millimeters. In the production of the composite materials of the present invention it is preferred that the foamable material from which the foam is produced have a thickness in the unfoamed state of from 1 to 5 millimeters, preferably 2 to 4 millimeters more preferably 2 to 3.5 millimeters. The foamable materials may expand a desired amount based on a given application. The foamable materials in a foamed state may have a thickness of about 100% greater or more, about 300% greater or more, or about 600% greater or more relative to a thickness in the unfoamed state. The foamable materials in a foamed state may have a thickness of about 1200% or less, about 1000% or less, or about 8% or less relative to a thickness in the unfoamed state.

It may be gleaned from the present teachings that a rate of expansion of the foamable materials may be tuned based on one or more components of the foamable materials. The one or more components of the foamable materials may be a blowing agent. The blowing agent may be a chemical blowing agent or a physical blowing agent. For example, the foamable materials may include a blowing agent such as expandable microspheres that may be configured to expand at a given temperature. The expandable microspheres may expand at a temperature of about 100° C. or more, about 150° C. or more, or about 200° C. or more. The expandable microspheres may expand at a temperature of about 400° C. or less, about 300° C. or less, or about 250° C. or less. The activation temperature for the foamable materials (e.g., the expandable microspheres of the blowing agent) may be determined by selecting different grades of blowing agents (e.g., by selecting different grades of expandable microspheres).

The foamable materials may undergo a single expansion or may undergo multiple expansions. The foamable materials may be foamed to a first percent expansion, contacted with a fiber and/or fiber/resin matrix layer and then located into a mold where the foam expands to a second percent expansion. The first percent expansion may be greater than the second percent expansion. The second percent expansion may be greater than the first percent expansion.

It is possible that the fiber surface layers are coated (e.g., impregnated) with a resin material to form a fiber/resin matrix material. The matrix layers may then be contacted with one or more foamable layers to form a hollow composite that can be molded without need for an air bladder.

The composite materials described herein may also include fibrous materials that employ a distributed phase (e.g., a fibrous phase) and a thermoplastic polymeric material (e.g., a reformable resin, a thermoplastic reaction product having at least one epoxide group). The material offers the benefit of mechanical properties typically achieved through the use of thermoset polymeric materials (e.g., a thermoset epoxy material) as some or all of a matrix phase of a composite. However, the material has a number of physical attributes that make it suitable for handling, processing and/or post-useful life reclamation, recycling, and/or re-use.

The teachings contemplate the possibility that a structure may be fabricated using the composites described herein which may include a resin material, a foamable material, or both which may each be thermoplastic or thermoset in nature. In particular, the structure may be made from a thermoplastic or thermoset material in accordance with the present teachings that is reinforced with a reinforcement phase (e.g., a fiber material). The reinforcement phase may be distributed in a matrix of the thermoplastic or thermoset material (e.g., a polyamide, a polyurethane and/or a reformable resin material as described herein). For example, the reinforcement phase may be at least a majority (by volume) of the total material. It may be greater than about 60% by volume or greater than about 70% by volume. It may be below about 90% by volume, below about 80% by volume, or below about 70% by volume. Any reinforcement phase may be distributed randomly, generally uniformly, and/or in one or more predetermined locations of the part.

The ratio by weight of polymeric resin to the fibers may be range from about 1:10 to about 100:1 (e.g., it may range from about 1:5 to about 10:1, about 1:3 to about 5:1, or even about 1:2 to about 2:1).

The material of the distributed phase may include an organic material, an inorganic material or a combination of each. The material may be a naturally occurring material (e.g., a rubber, a cellulose, sisal, jute, hemp, or some other naturally occurring material). It may be a synthetic material (e.g., a polymer (which may be a homopolymer, a copolymer, a terpolymer, a blend, or any combination thereof)). It may be a carbon derived material (e.g., carbon fiber, graphite, graphene, or otherwise). The distributed phase may thus include fibers selected from (organic or inorganic) mineral fibers (e.g., glass fibers, such as E-glass fibers, S-glass, B-glass or otherwise), polymeric fibers (e.g., an aramid fiber, a cellulose fiber, or otherwise), carbon fibers, metal fibers, natural fibers (e.g., derived from an agricultural source), or any combination thereof. The plurality of elongated fibers may be oriented generally parallel to each other. They may be braided. They may be twisted. Collections of fibers may be woven and/or nonwoven.

The material of the distributed phase may include a plurality of fibers having a length of at least about 1 cm, 3 cm or even 5 cm or longer. Fibers of the distributed phase may have an average diameter of about 1 to about 50 microns (e.g., about 5 to about 25 microns). The fibers may have a suitable sizing coating thereon. The fibers may be present in each layer, or in the fibrous insert generally, in an amount of at least about 20%, 30%, 40% or even 50% by weight. The fibers may be present in each layer, or in the fibrous insert generally, in an amount below about 90%, 80%, or even about 70%, by weight. By way of example, the fibers may be present in each layer, or in the fibrous insert, in an amount of about 50% to about 70% by weight. Fiber contents by weight may be determined in accordance with ASTM D2584-11.

The resulting composites may exhibit one or any combination of the following characteristics: a tensile strength at yield (according to ASTM D638-14) of at least about 15 MPa (e.g., at least about 30 MPa or 45 MPa), a tensile elongation strength at break (according to ASTM D638-14) of at least about 40 MPa (e.g., at least about 45 or 55 MPa); an elongation at break (according to ASTM D638-14) of at least about 15% (e.g., at least about 20%, 25 or 30%); and/or a tensile modulus of elasticity (according to ASTM D638-14) of at least about 0.5 GPa, (e.g., at least about 1 GPa, 1.8 GPa, or 2.7 GPa).

The resulting composites may have a predetermined shape. The shape may include one or more elongated portions. The shape may include one or more hollow portions. The shape may include one or more walls that define at least one cavity. The structure may include a plurality of portions each having a different shape. The structure may be configured to define a fascia, which optionally may be supported by an underlying structure. The structure may be configured to define a support that underlies a fascia.

The composites may be formed using a variety of methods. The method may include a step of at least partially shaping the composite structure. For example, a tool may be preheated to a temperature above the softening temperature and/or the melting temperature of a polymer of the at least one composite layer prior to placing the composite in the cavity of the tool. Pressure that results from expansion of the foamable layers may be suitable to push the surface layers out to the wall of the mold, eliminating the need for any air bladder structures.

It is contemplated that the materials as disclosed herein may be paintable. Paintability may be desirable, for example, if any surface is visibly exposed. The material may be ink jet printed. The material may be paintable, as it may have an affinity for taking paint. This may be due, at least in part, to the polarity of the material and/or the hydroxyl functionality of the backbone (e.g., generally linear backbone polymer chain) in the event that the matrix material is a reformable resin.

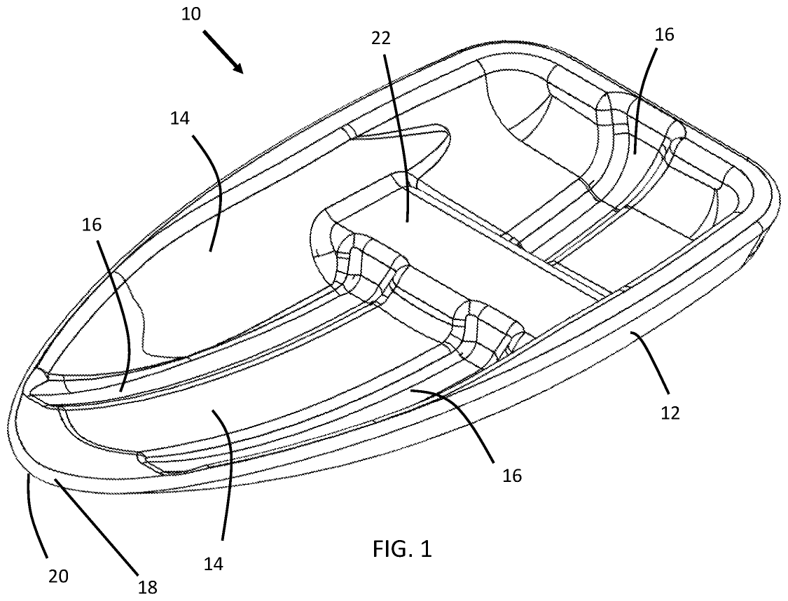

Turning now to the figures, FIG. 1 illustrates a perspective view of a composite 10 in accordance with the present teachings. As shown, the composite 10 may include an outer contoured surface 12 and an inner contoured surface 14. However, it should be noted that the composite 10 may include one or more flat surfaces instead of the contoured surfaces 12,14. The composite 10 may also include a flat portion 22 along an inner portion of the composite 10.

A plurality of ribs 16 may extend substantially along a length of the composite 10. It is envisioned that the ribs 16 may be any desired size and/or shape. The ribs 16 may extend in any desired direction along the composite 10. The ribs 16 may improve structural integrity of the composite 10. The ribs 16 may also follow a desired surface of a secondary component or structure receiving the composite 10.

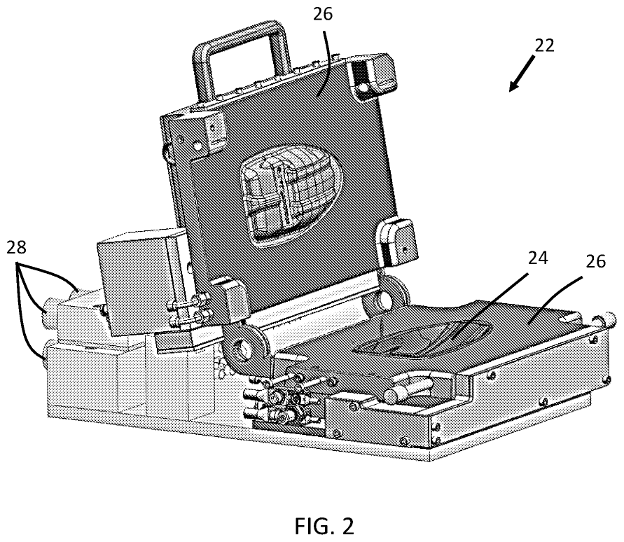

The composite 10 may include a nose portion 20 that includes a substantially arcuate segment along a perimeter. The nose portion 20 may include a lip 18 extending along a terminal edge of the composite 10. The lip 18 may extend substantially around a portion or all of a perimeter of the composite 10. It is envisioned that the composite 10 disclosed herein may be manufactured to have one or more complex shapes. For example, the composite 10 may include one or more contoured portions, one or more arcuate portions, one or more bends, one or more steps, one or more lips, or a combination thereof. The complex shapes of the composite 10 may be facilitated by a method of manufacturing of the composite 10 (see FIG. 2), materials selected for the composite 10, or both.

FIG. 2 illustrates a perspective view of a tool 22 for manufacturing composites 10 as illustrated in FIG. 1. The tool 22 may include a cavity 24. The cavity may be configured to receive the composite material in an uncured state. For example, the composite material in an uncured state may be pumpable so that the composite material may be pumped directly into the cavity 24. Alternatively, the composite material in an uncured state may be preformed and inserted into the cavity 24. The preformed composite material may have a size less than a size of the cavity 24 to allow for expansion of the preformed composite material. The cavity 24, tool surfaces 26 along the cavity 24, or both may be heated to cure the composite material and form a resultant composite.

It is envisioned that the cavity 24 may be rapidly heated and cooled to improve overall efficiency of the manufacturing process. For example, a temperature of the cavity 24 may be increased to a desired heating temperature and then rapidly cooled to a desired cooling temperature in a short cycle time. The cycle time may be about 30 seconds or more, about 60 seconds or more, or about 90 seconds or more. The cycle time may be about 180 seconds or less, about 150 seconds or less, or about 120 minutes or less. Accordingly, it is envisioned that the composite material may withstand rigorous and rapid changes in temperature. For example, the temperature may range from about 30° C. or more, about 50° C. or more, or about 70° C. or more to about 200° C. or more, about 250° C. or more, or about 300° C. or more. The temperature may range from about 150° C. or less, about 100° C. or less, or about 85° C. or less to about 500° C. or less, about 400° C. or less, or about 350° C. or less. As such, the composite material may expand, cure, or both very quickly during the cycle time to provide a finished composite 10. For example, the composite material may be injected into the cavity 24. Once the cavity 24 is filled with a desired amount of the composite material, the cavity 24 and/or tool surfaces 26 may be rapidly heated to expand and/or cure the composite material. The composite material may then fill substantially an entirety of the cavity 24. The cavity 24 may then be rapidly cooled, resulting in a cured and final composite 10.

It should be noted that the cavity 24 may be rapidly heated and cooled in any desired manner. However, it is envisioned that the cavity 24 may be heated rapidly via induction heating. The heating may be powered by one or more generators (not shown) electrically connected to the tool 24. The generators may power one or more desired cycle outputs (e.g., a single zone, dual zone, etc.) based on identical or different parameters to heat the cavity 24. The cycle outputs may be output simultaneously or in a varied manner. The generators may have any desired power outputs based on a given application.

The cavity 24 may also be rapidly cooled in any desired manner. However, it is envisioned that the cavity 24 may be rapidly cooled via an external cooling unit (not shown). The external cooling unit may be connected to the tool 22 via one or more ports 28. The external cooling unit may include a hydraulic module to cool the tool 22. The cooling unit may be a closed loop cooling unit or may be an open loop system. The cooling unit may use one or more liquids to rapidly cool and dissipate heat from the tool 22. For example, the cooling unit may cool the tool 22 using water being pushed through one or more channels connected to the tool 22.

It should also be noted that the cavity 24 may also include one or more additional materials to form a result composite 10. For example, a liner or shell may be molded in the cavity 24 first and then the composite material may be injected into the cavity 24. As such, the composite material may fill one or more voids of a shell or secondary material. Upon expanding and curing, the composite material may bond to the secondary material to form the resultant composite 10. Therefore, the composite 10 described herein may be formed in a single tool 22 free of secondary operations needed in conventional manufacturing processes. For example, the manufacturing process for the composite 10 may be free of pre-forming the composite and machining the composite to a desired shape before bonding secondary components or layers to the composite. Instead, the composite 10 may be shaped and bonded to secondary components in the same tool.

### ELEMENT LIST

10 Composite
12 Outer Contoured Surface
14 Inner Contoured Surface
16 Rib
18 Lip
20 Nose Portion
22 Flat Portion
22 Tool
24 Cavity
26 Tool Surface
28 Ports

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the of a range in terms of “at least ‘x’ parts by weight of the resulting composition” also contemplates a teaching of ranges of same recited amount of “x” in percent by weight of the resulting composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for ail purposes. The term “consisting essentially of to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist of, or consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A structure comprising:
i) a fiber and resin matrix material layer at least partially forming a hollow section of the structure; and
ii) a foamable material layer in direct planar contact with the fiber and resin matrix material layer, the foamable material layer at least partially filling the hollow section, wherein the foamable material layer has a first expansion upon exposure to a first temperature and a second expansion upon exposure to a second temperature.

2. The structure of claim 1, wherein the fiber comprises a carbon fiber, a polymeric fiber, a polyamide liber, a glass fiber, or a combination thereof.

3. The structure of claim 2, wherein the resin comprises an epoxy material.

4. The structure of claim 1, wherein the resin comprises a polyurethane material.

5. (canceled)

6. The structure of claim 1, wherein the second expansion occurs in a molding device.

7-9. (canceled)

10. The structure of claim 1, wherein the foamable material expands upon exposure to a predetermined temperature.

11. The structure of claim 1, wherein the foamable material is a structural foam, a sealing material, a polymeric foam, or a combination thereof.

12. (canceled)

13. (canceled)

14. The structure of claim 1, wherein the foamable material comprises an epoxy resin, a phenoxy resin, an acetate (e.g., EVA or EMA), or any combination thereof.

15. (canceled)

16. The structure of claim 1, wherein the resin comprises a reformable resin material.

17. The structure of claim 1, wherein the structure is an elongated hollow part.

18. The structure of claim 1, wherein the resin material is a thermoset material.

19. The structure of claim 1, wherein the resin material is a thermoplastic material.

20. The structure of claim 1, wherein the structure forms a portion of a frame member.

21. The structure of claim 1, wherein the structure is used as a building component, a component in a transportation vehicle, a furniture component or a sporting good component.

22. The structure of claim 1, wherein the structure forms a portion of a bicycle frame.

23. The structure of claim 6, wherein the molding device is rapidly cooled and heated.

24. The structure of claim 23, wherein the molding device is rapidly heated by inductively heating a cavity of the molding device.

25. The structure of claim 24, wherein the molding device is rapidly cooled using water flowing through one or more loops in communication with the molding device.

26. The structure of claim 25, wherein the rapid cooling is completed using a closed-loop cooling system.

27. The structure of claim 25, wherein the rapid cooling is completed using an open-loop cooling system.
